(19) United States
(12) Patent Application Publication
(10) Pub. No.: US 2025/0353527 A1
(43) Pub. Date: Nov. 20, 2025

(54) ANALYTICAL ADAPTIVE ALGORITHM FOR AUTONOMOUS RACE DRIVING

(71) Applicant: University of South Florida, Tampa, FL (US)

(72) Inventors: Neilesh SAMBHU, Tampa, FL (US); Srinivas KATKOORI, Wesley Chapel, FL (US)

(21) Appl. No.: 19/211,113

(22) Filed: May 16, 2025

Related U.S. Application Data
(60) Provisional application No. 63/648,527, filed on May 16, 2024.

(51) Int. Cl. B60W 60/00; B60W 10/04; B60W 10/18; B60W 10/20; B60W 30/10; B60W 50/00; B60W 50/08

(52) U.S. Cl. CPC B60W 60/0011; B60W 10/04; B60W 10/18; B60W 10/20; B60W 30/10; B60W 50/085; B60W 2050/0063; B60W 2510/00; B60W 2510/18; B60W 2510/20; B60W 2520/10; B60W 2556/50; B60W 2710/00; B60W 2710/18; B60W 2710/20; B60W 2720/10

(57) ABSTRACT

The present disclosure provides systems and methods for determining autonomous vehicle navigation settings and/or adjustments. In some aspects, vehicles may comprise an environmental sensor, processor, a navigation controller, and software causing the systems to utilize current location information, extrapolated location information, and a priori path locations, along with vehicle control settings, to output updated steering, braking, and throttling settings. In some aspects, methods may be utilized that reliably determine deviation from a known path that would be caused by current vehicle settings, and use the deviation to adjust the vehicle settings to improve following of the path, while optimizing vehicle attributes like speed, fuel economy, tire wear, or the like as able given primary navigation goals.

### CROSS REFERENCE TO RELATED APPLICATIONS

This application claims priority to U.S. provisional patent application No. 63/648,527, filed May 16, 2024, the entire content of which is incorporated herein by reference.

### STATEMENT OF GOVERNMENT SUPPORT

N/A

### BACKGROUND

Self-driving cars (SDCs) may use deep learning and convolutional neural networks (CNNs) to understand their environment and determine driving goals.

To solve full autonomy, however, autonomous vehicles must be able to operate in challenging road conditions in which the expected movement of the vehicle does not wind up matching the actual movement of the vehicle. Thus, full autonomy requires an understanding of vehicle navigation.

Track driving for race vehicles (and other similar route-based scenarios) is a particularly difficult problem to solve because (1) the car needs to find the path to drive around the track; (2) the optimal path to drive the lap changes as the car begins to drive faster; and (3) optimization of the drive involves continuous values in time and space (i.e., discretizing the track space is a precondition for optimizing lap time).

### SUMMARY

The following presents a simplified summary of the disclosed technology herein in order to provide a basic understanding of some aspects of the disclosed technology. This summary is not an extensive overview of the disclosed technology. It is intended neither to identify key or critical elements of the disclosed technology nor to delineate the scope of the disclosed technology. Its sole purpose is to present some concepts of the disclosed technology in a simplified form as a prelude to the more detailed description that is presented later.

In some aspects, the present disclosure can provide systems and methods for autonomous vehicle navigation, that intelligently take into account current navigation settings and prior path following data. For example, autonomously driving vehicles are provided, that may comprising at least one environmental sensor; a processor; a controller connected to a steering system, a brake system, and an acceleration system; a memory having instructions stored thereon that, when executed, cause the controller to: receive data corresponding to physical locations within an environment in which the vehicle is operating, at least one of the physical locations associated with a target location; determine a ground truth path within the environment, based on the plurality of GPS locations, wherein the ground truth path comprises a plurality of ground truth path locations; obtain, using the at least one environmental sensor, a current vehicle location; determine an extrapolated vehicle location based on a plurality of operating parameters of the steering system, the brake system, and the acceleration system; compare the extrapolated vehicle location to each location of the plurality of ground truth path locations; output a throttle value, a steer value, and a brake value based on a closest location of the plurality of ground truth locations; and adjust the plurality of operating parameters of the steering system, the brake system, and the acceleration system based on the throttle value, the steer value, and the brake value.

In further aspects, the present disclosure may provide such systems and methods which also apply goal-based state optimization algorithms. For example, vehicles and systems may employ greedy or optimizing algorithms that increase or decrease the determined steering, throttle, and brake values from primary navigation calculations within allowable limits (e.g., at permissible increments/decrements, or according to threshold constraints) in order to provide for faster path navigation (e.g., maximizing speed as possible), tire wear (limiting large steering angle changes abruptly), and/or fuel economy (e.g., limiting abrupt or excessive braking).

### BRIEF DESCRIPTION OF THE DRAWINGS

The foregoing features of embodiments will be more readily understood by reference to the following detailed description, taken with reference to the accompanying drawings, in which:

FIG. 1 is a flow diagram representing a process for autonomous vehicle operation in accordance with some aspects of the present disclosure.

FIG. 2 is a block diagram representing certain hardware configurations.

FIG. 3 is a view of an example route or track environment.

FIG. 4 is an example process or algorithm according to some aspects of the disclosure.

FIG. 5 is a comparison chart of data obtained from various validation experiments.

FIG. 6 is another comparison chart of data obtained from various validation experiments.

FIG. 7 is an overlay plot of results obtained from an experiment.

FIG. 8 is an example process or algorithm according to some aspects of the disclosure.

FIG. 9 is an example process or algorithm according to some aspects of the disclosure.

FIG. 10 is an example process or algorithm according to some aspects of the disclosure.

FIG. 11 is another comparison chart of data obtained from various validation experiments.

FIG. 12 is a flowchart illustrating a process for vehicle navigation accounting for actual vehicle movement, in accordance with aspects of the present disclosure.

### DETAILED DESCRIPTION

The following description will provide a disclosure of various features, approaches, and aspects of example systems and methods that can overcome the limitations described above, and allow for more usable, inter-operable, scalable, dynamic, robust, and effective platooning of vehicles. First, a general description will be provided of aspects of technologies that may be utilized in systems and methods of the present disclosure. Second, an overview of illustrative system/hardware architectures will be provided along with an overview of a framework for deploying certain processes and algorithms of the present disclosure. Third, a description of the inventors' experiments and validation studies will be provided.

Described here are systems and methods directed to an analytical self driving algorithm for race driving, track driving, and other route-based driving environments. In some embodiments, the self-driving algorithm may use a baseline (i.e., generated a priori by manually driving on the track or route) for course correction while attempting to achieve the shortest (or otherwise optimal) lap time. The proposed algorithm iteratively determines the steer angle, throttle, and brake controls while adhering as close to the baseline, by computing deviations between (1) the predicted location at the next time step and (2) the baseline location closest to predicted. Results are included below for various fixed speeds to demonstrate the correctness of the algorithm.

Additionally, optimization approaches are also provided, which take into account realistic adaptive driving, and greedily optimize vehicle states or characteristics (e.g., increases the speed) whenever the algorithm determines that the optimization changes are allowable given needs for primary navigation changes (e.g., when the steering correction is small, speed can be increased; or when a larger steering change is made (or will be made), such as for a curve, throttle can be reduced while braking avoided in order to improve fuel efficiency).

The present disclosure will now provide overview descriptions of various approaches to deploying embodiments of autonomous driving methods. It should be understood that the processes and algorithms described below are not limiting of the scope of this disclosure, can be combined in various configurations, and may be adapted to replace, complement, and/or fit with attributes and needs of different vehicles, vehicle capabilities, roadway types, race goals, jurisdictional laws and requirements, etc.

### Example Adaptive Autonomous Driving Process

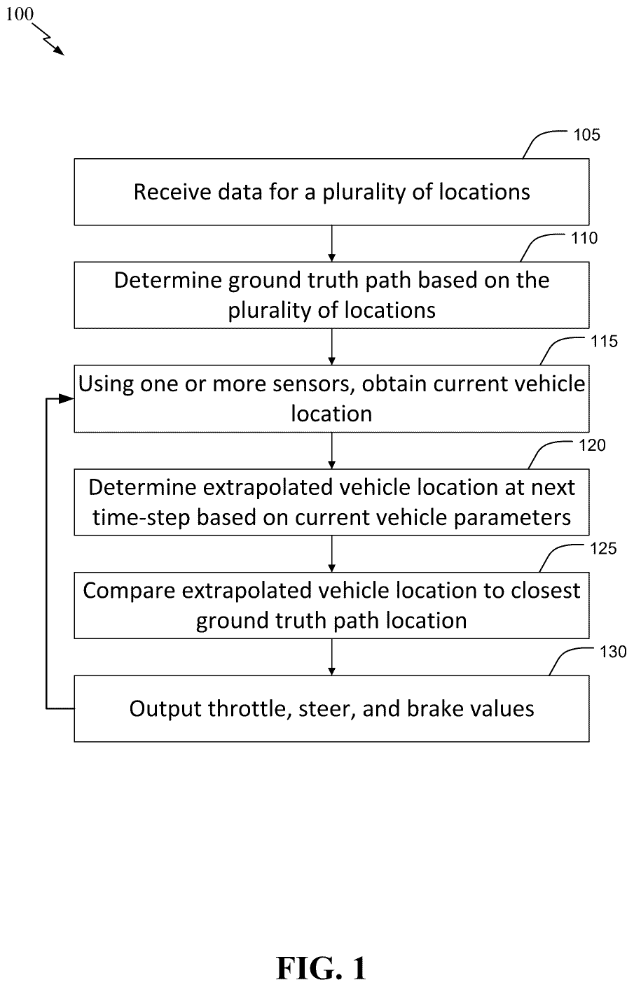

FIG. 1 illustrates a process 100 for performing autonomous driving of a given vehicle. The vehicle may be equipped with an integrated, OEM communication and control system (including software to cause performance of the steps of process 100), or may be equipped with an aftermarket module as further described below in the “Hardware” section. Additionally, the host vehicle may comprise any level of automated driving—the following description will note where alternatives or differences in the steps could be utilized depending on vehicle capabilities. As described below, a particular implementation can omit some or all illustrated features/steps, may be implemented in some embodiments in a different order, and may not require some illustrated features to implement all embodiments. It should be appreciated that other suitable processing hardware for carrying out the operations or features described below may perform process 100.

At step 105, the process 100 receives a plurality of locations. In some examples, the locations may be received from satellites transmitting signals corresponding to locations in a specific environment or map, a camera, a Li-Dar sensor, or the like. Moreover, in some examples, the locations may be received as a text file containing three-dimensional locations, a decimal-degree coordinate, degree-minute-second (DMS) coordinate, or the like.

At step 110, the process 100 determines a ground truth path based on the plurality of GPS locations. In some examples, the ground truth path may represent a single road, a race track/course, one or more interconnected roads, a navigation route, or the like. For example, the ground truth map may define an outer perimeter of a map for a given environment, a delivery route, a bus route, or a segment of roadway. The ground truth information may be determined by a vehicle first driving the road/course/route/etc. itself and recording location information (e.g., from GPS, from depth/Li-DAR sensing of unique surroundings, etc.) or may be based on accumulated data from many vehicles driving the same route over time (e.g., mobile apps storing GPS information for a route)

At step 115, the process 100 obtains a current location of the vehicle using one or more sensors. In some examples, the current location may be an x-y pair representing coordinates of the vehicle on a map or in a given environment.

At step 120, the process 100 determines an extrapolated vehicle location at a next time-step based on current operating parameters of the vehicle. For example, the extrapolated vehicle location may be determined by assuming the vehicle will remain at a constant steer angle, throttle position, and brake position (a set of known vehicle control states) at the current values of those characteristics, for a given time increment.

At step 125, the process 100 compares the extrapolated vehicle location to a closest location on the ground truth path. In some examples, the ground truth path determined at step 110 may include a progression of ground truth coordinates. For example, each ground truth coordinate may be compared to the extrapolated vehicle location. The closest location on the ground truth path may correspond to the ground truth coordinate nearest to a coordinate of the extrapolated vehicle location.

At step 130, the process 100 outputs a determined throttle value, a determined steer value, and a determined brake value. In some examples, a command may be broadcasted that adjusts the vehicle's speed and direction. In some examples, the vehicle may execute these commands autonomously using an onboard control system. The determined values may be determined based on a target speed, a maximum steering angle, and a desired direction for a given coordinate point on the ground truth path.

### Example Hardware Configuration

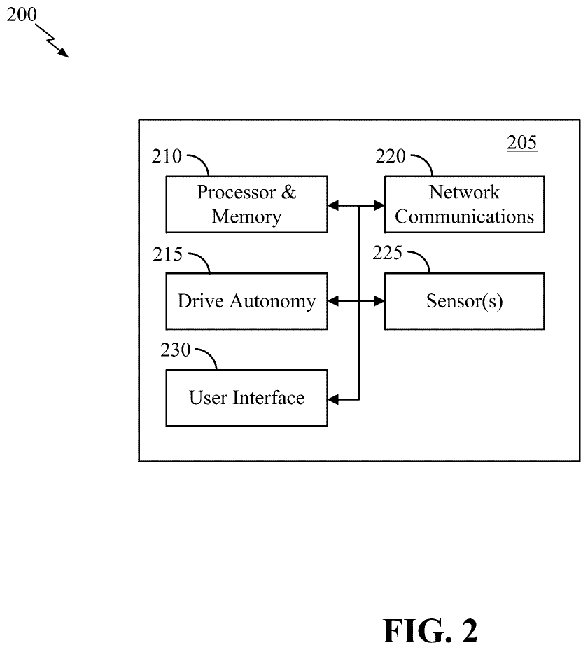

Referring now to FIG. 2, a block diagram is shown illustrating a system architecture for implementing the method described above with respect to FIG. 1. The system comprises a vehicle 205, which may perform some or all of the steps of the method described above. The vehicle 205 includes an integrated system comprising hardware and software components for executing platooning algorithms. This system is capable of operating natively using the vehicle's existing original equipment manufacturer (OEM) hardware and software. Key components of vehicle 610 include a processor and memory module 210 for executing autonomous driving and maintaining operational data, a drive autonomy module 215 for controlling vehicle movement (e.g., steer angle, throttle control, brake control, etc.), a network communications module 220 for managing external communications, and a sensor array 225. The sensor array may include cameras, LIDAR, radar, or other sensing equipment for detecting surrounding vehicles and road conditions, and/or a GPS receiver. The vehicle further includes a user interface 230, which may provide feedback to a driver or display status updates regarding platoon operations.

In some embodiments, the processor of the vehicle can be any suitable hardware processor or combination of processors, such as a central processing unit (CPU), a graphics processing unit (GPU), an application specific integrated circuit (ASIC), a field-programmable gate array (FPGA), a digital signal processor (DSP), a microcontroller (MCU), etc. The processor may reflect general-purpose computational resources that control the entire vehicle, or may be dedicated processing resources for autonomous driving functions. Thus, in some embodiments, a custom chip may be utilized that comprises a transistor layout to specifically carry out some or all of the algorithms described herein. In this manner, more rapid calculation of navigation information can be reliably performed. In some embodiments, the output of such chip may then used to supplement, or replace some or all of, the core autonomous driving software of the vehicle.

Similarly, the memory can include any suitable storage device or devices that can be used to store suitable data (e.g., software to run the self-driving algorithms described here, user settings, GPS information, sensor data, and any other data or information used in performing autonomous driving described herein). The memory can include a non-transitory computer-readable medium including any suitable volatile memory, non-volatile memory, storage, or any suitable combination thereof. For example, memory can include random access memory (RAM), read-only memory (ROM), electronically-erasable programmable read-only memory (EEPROM), one or more flash drives, one or more hard disks, one or more solid state drives, one or more optical drives, etc.

The network communications systems of the vehicles can include any suitable hardware, firmware, and/or software for communicating information over an Internet communication network and/or any other suitable communication networks. For example, the network communications module 220 can include one or more transceivers, one or more communication chips and/or chip sets, etc. In a more particular example, the network communications module 220 can include hardware, firmware and/or software that can be used to establish a Wi-Fi connection, a Bluetooth connection, a cellular connection (e.g., a 3G network, a 4G network, a 5G network, etc., complying with any suitable standard, such as CDMA, GSM, LTE, LTE Advanced, NR, etc.), a satellite connection, combinations thereof, etc. In some embodiments, the communications system may be native to the OEM hardware of the vehicle, whereas in other embodiments the communications system may be specific to an aftermarket module or third party device.

The user interface 230 of the vehicle may include visual and/or audio presentation to drivers. In some embodiments, the user interface 230 may include any suitable display devices, such as a native dashboard display screen, a touchscreen, an infotainment screen, a mobile device, or simple directional and numeric light up indicators, etc. to display information to a driver at various points in performance of the methods described herein.

The sensor(s) 225 of the vehicle may include vision sensors (e.g., optical 2D, stereo, depth, etc. cameras and detectors), infrared sensors, Radar systems, LiDAR systems (3D, solid state, etc.), ultrasonic systems, etc. The sensor(s) may also include GPS modules, IMU-type sensors (accelerometers, gyroscopes, magnetometers), odometry sensors, fuel/charge sensors, traction and ABS sensors, and other native sensors of the vehicle that detect its driving behavior (brake sensors, signaling light sensors, steering sensors, etc.). The sensor(s) may also include environmental sensors, such as rain sensors, temperature sensors, barometers, sunlight/ambient light sensors, acoustic sensors, and the like.

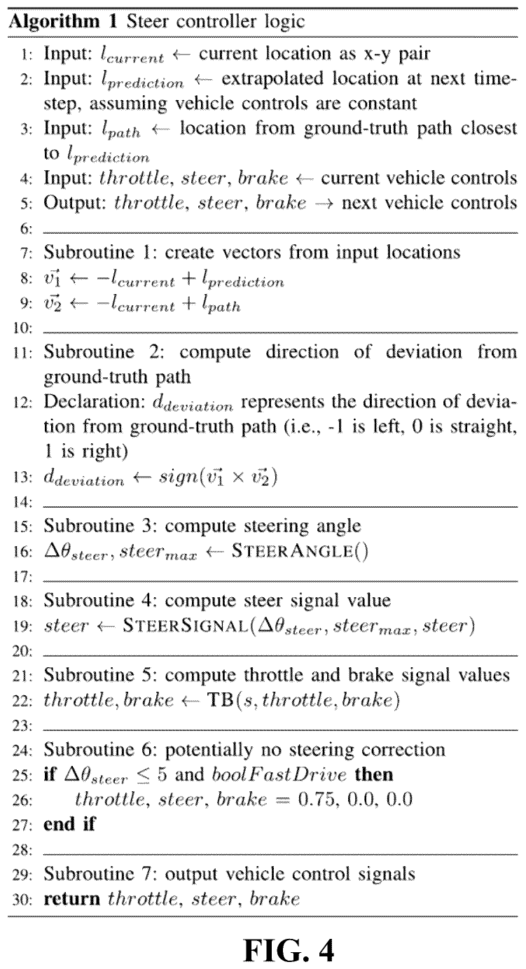

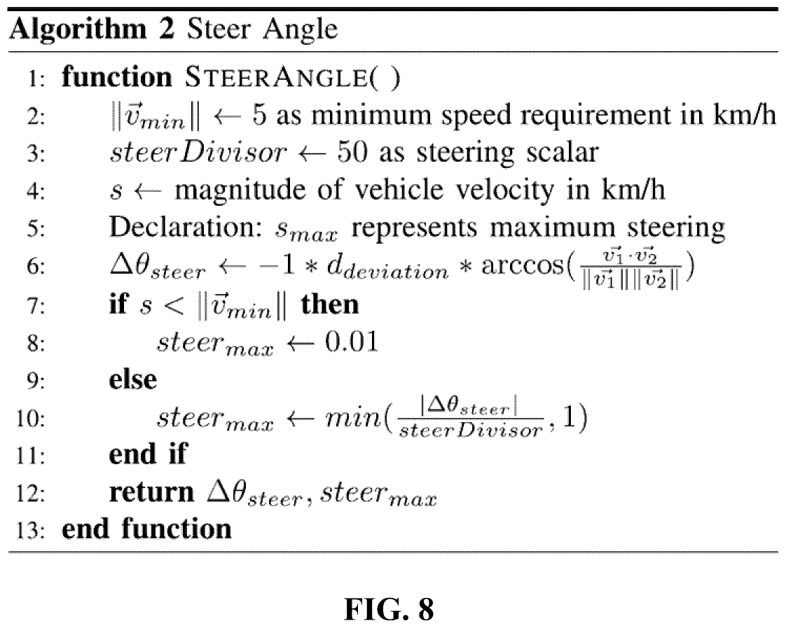

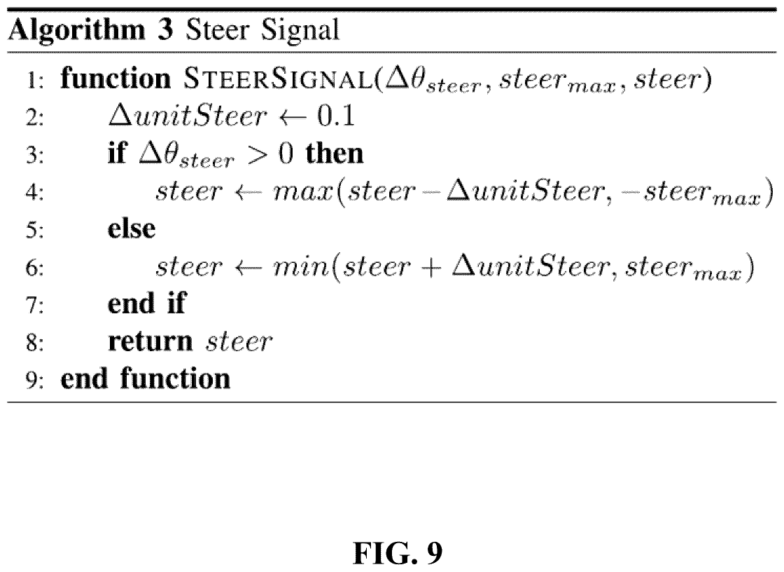

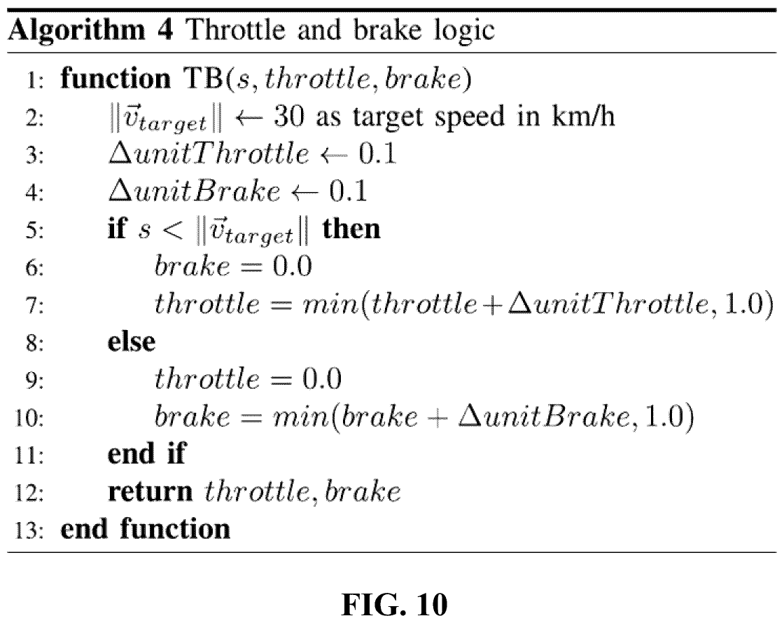

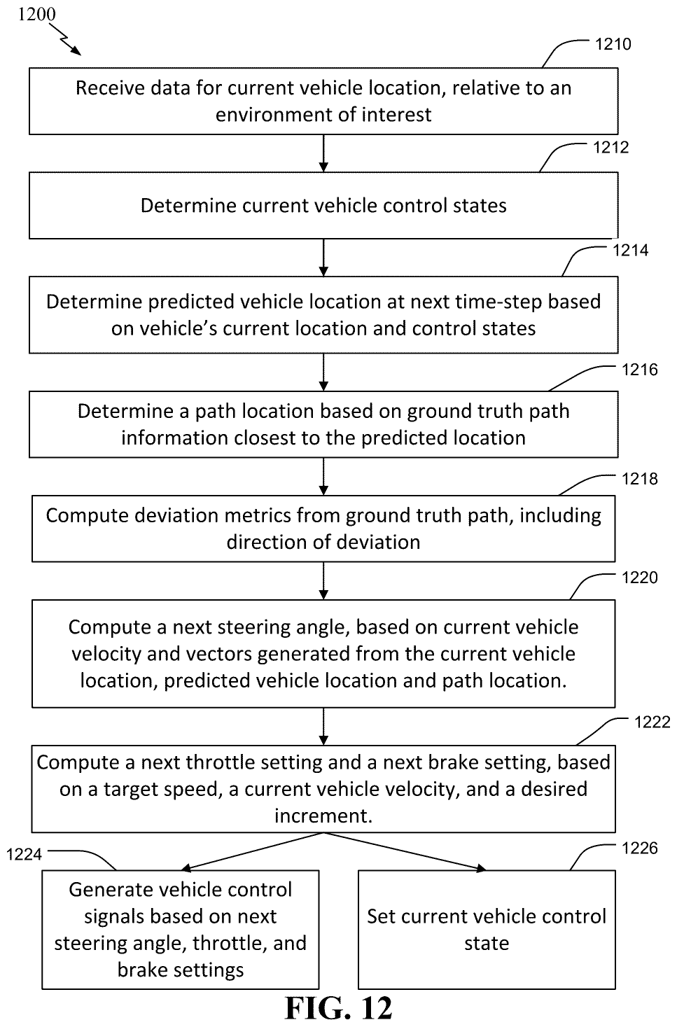

Referring now to FIG. 12, a flowchart is shown depicting an example process for adjusting an autonomous vehicle's navigation control signals. Process 1200 may be utilized as the sole method for generating navigation controls, or may be used in combination with a native or OEM navigation system for the autonomous vehicle. Process 1200 may be executed by a computing system onboard an autonomous or semi-autonomous vehicle or in communication therewith. Process 1200 may be performed using some or all of the inputs, outputs, routines, steps, calculations, and determinations set forth in the Algorithms shown in FIG. 4, FIG. 8, FIG. 9, and/or FIG. 10.

At block 1210, the system may receive data indicative of a current vehicle location for the vehicle performing process 1200. In some implementations, the location may be determined in two dimensions relative to a mapped or sensed environment of interest, such as a given course, track, route, or geographic area. In alternative embodiments, the location information may be (or may also include) location information determined relative to fixed landmarks within the environment, such as passive or active wireless broadcasting posts, or the like. Or, the location may be relative to native landmarks, such as using environment-relative positioning systems such as LiDAR, visual odometry, or simultaneous localization and mapping (SLAM) techniques. In other embodiments, the location information may be from a global positioning system (GPS). The location may be expressed in local or global coordinate frames or in relation to detected features in the environment.

At block 1212, the system may determine a current vehicle control state. In various embodiments, the vehicle control state may include settings or values determined by the vehicle from throttle, steering, and brake inputs currently being applied to the vehicle. In some implementations, the control state may additionally include current fuel or energy consumption, or a rate of change of fuel or energy consumption, which may be used to inform optimization routines or energy-aware control strategies.

At block 1214, the system may determine a predicted vehicle location at a next time-step, based on the vehicle's current location and the control states determined in block 1212. This prediction may be computed assuming the current control signals remain constant over a defined time increment.

At block 1216, the system may identify a location along a predefined ground-truth path that is closest to the predicted vehicle location determined in block 1214. In some implementations, the ground-truth path may be stored as a series of discrete location points forming a closed-loop or open route through a driving environment. In some embodiments, vectors (e.g., v1 and v2) may be generated based on the current-to-predicted location and current-to-path location. In some embodiments, vectors may also be generated for subsequent time steps and/or stored from previous time steps, where an optimization algorithm may take them into account.

At block 1218, the system may compute one or more deviation metrics based on the difference between the predicted vehicle location and the nearest ground-truth path location. The deviation metrics may include a magnitude of deviation and a direction of deviation, such as a left or right departure from the path, which may be determined based on a cross-product or other vector-based approach.

At block 1220, the system may compute a next steering angle. The steering angle may be computed using a function of the current vehicle velocity and the geometric relationship between vectors formed from: (1) the current vehicle location to the predicted vehicle location, and/or (2) the current vehicle location to the nearest path location. In some embodiments, a scalar divisor, a maximum angle limit, and other thresholds may be applied to the computed angle to regulate the aggressiveness of the correction. In further embodiments, the steering angle may be transformed into an adjustment or weight that is applied to a native autonomous navigation system's calculation of steering angle, to assist in correcting steering angle by taking into account actual path adjustments.

At block 1222, the system may compute a next throttle setting and a next brake setting. These values may be based on a comparison between a defined target speed and the current vehicle velocity. The control signals may be incrementally increased or decreased by fixed values (e.g., 0.1 units) depending on whether the vehicle is below or above the target speed. In some embodiments, the algorithm set forth in FIG. 10 may be utilized for determination of the next throttle and brake settings.

At block 1224, the system may generate updated vehicle control signals based on the steering angle, throttle setting, and brake setting computed in the preceding steps. These control signals may be used to issue commands to the vehicle's actuators or control interface, to cause the vehicle to implement the determined throttle, level of braking, steering angle, etc.

At block 1226, the system may update the current vehicle control state to reflect the applied control signals, enabling the process to be repeated at the next time-step using the updated state information.

### Example Implementations and Experiments

The inventors implemented the proposed algorithm in a Simulator. The steering controller started from the automatic control script of the simulator. One implementation makes use of the command-line arguments, connection to the simulator, vehicle spawning, and camera.

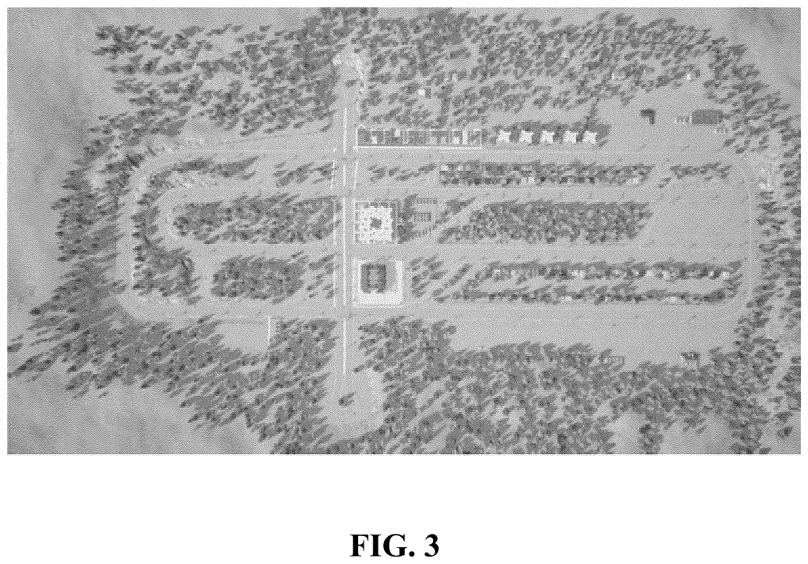

The script uses a text file of three-dimensional locations as input to create the ground-truth drive. The function getLocationClosestToCurrent ( ) takes as input a single location and outputs a pair of (1) the distance to the closest point and (2) the closest point. FIG. 3 illustrates an aerial view of a town in the simulation. The path follows an outer perimeter of the map, starting from the bottom-left corner of the map, passing through the four corners to come back to the start. As shown in FIG. 3, the ground-truth path in this paper uses Town 6.

FIG. 4 illustrates Algorithm 1: an algorithm containing steer controller logic. To use Algorithm 1, the user drives around the track manually to collect locations. These locations become the ground-truth path for the algorithm.

Assumptions for the algorithm to work are as follows: (1) precise location of GPS, (2) sensors are accurate for computing velocity, and (3) there is a real-time computer on board to compute the output for the vehicle controls (i.e., steer, brake, and throttle).

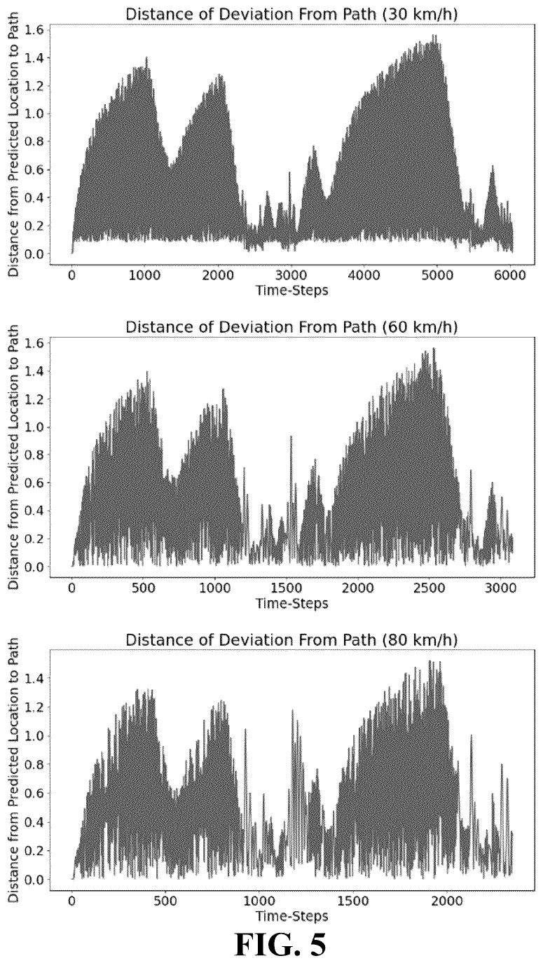

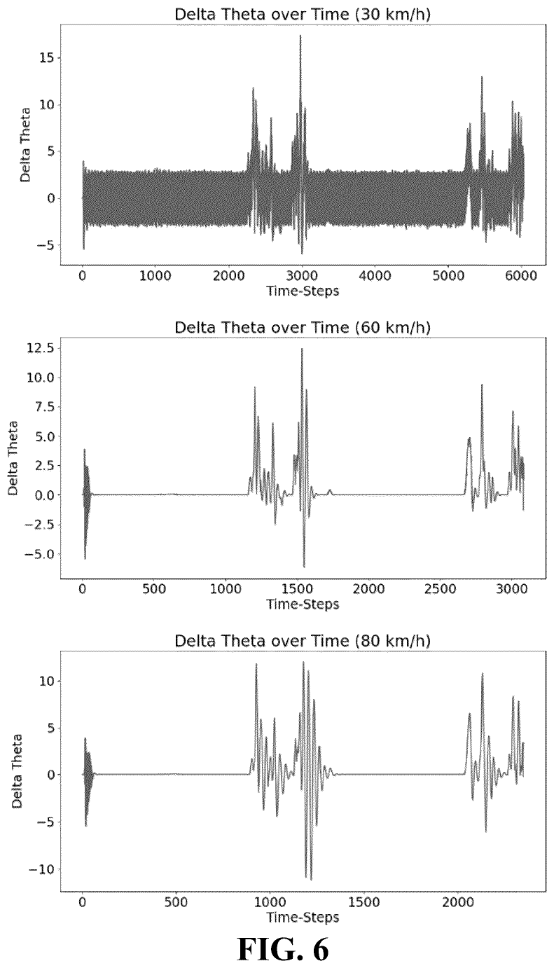

FIG. 5 illustrates graphs showing the distances from (1) the predicted location at the next time-step in the future and (2) the closest location from the ground-truth path at (3) target speeds of 30, 60, and 80 km/h. Each time-step is 1/20th of a second. FIG. 6 illustrates graphs showing (1) the computation of the computed corrective steering angle needed to maintain the vehicle trajectory on the path of the ground-truth drive (2) with respect to time at (3) target speeds of 30, 60, and 80 km/h.

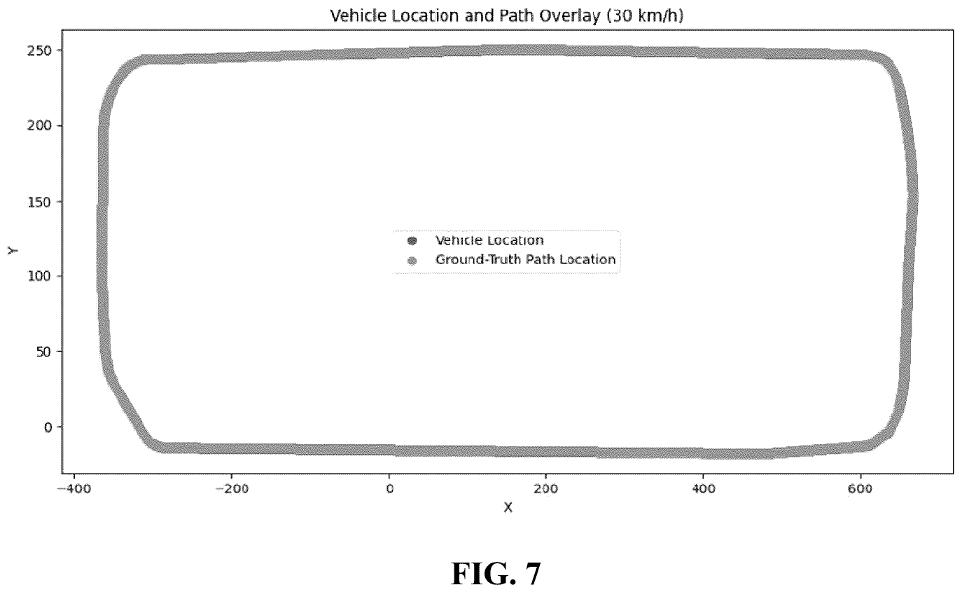

As shown in FIG. 6, the steering controller usually operates within bounds of 5 degrees of correction from the ground-truth path. From FIG. 7, the vehicle closely follows the ground-truth path. This approach omits machine learning and instead uses classical AI as trigonometry to implement the steering control of the vehicle.

Algorithm: As shown in Algorithm 1, the steering controller logic takes as input (1) three location values and (2) three scalars representing the current vehicle controls. Algorithm 1 outputs the vehicle controls for the next time-step.

Inputs and Outputs: The locations are x-y pairs representing (1) the current vehicle location; (2) the extrapolated vehicle location at the next time-step, assuming vehicle controls are constant; and (3) the location from the ground-truth path closest to the predicted vehicle location at the next time-step. The vehicle controls are scalar values of throttle e [0, 1], steer e [-1, 1], and brake ϵ[0, 1]. The output has the same format as the input: throttle, steer, and brake values for the next time-step.

Direction of Deviation: The first component of Algorithm 1 computes the direction of deviation from the ground-truth path. The current, predicted, and path locations are assigned to a, b, and c, respectively. The direction of deviation is the cross product of (1) the vector from the current to predicted locations with (2) the vector from the current to path locations. Algorithm 1 discretizes the deviation by sign (i.e., set deviation to −1 for negative values; set 1 for positive values).

Maximum Steering: The second component of Algorithm 1 computes the maximum steering value. The minimum speed requirement is 5 km/h. Algorithm 1 receives the vehicle speed. The algorithm uses the dot product to compute the angle between the vectors from the current location to the predicted and (2) path locations. To account for the angle the car needs to steer, Algorithm 1 multiplies the angle between the two vectors by the opposite sign of the direction of deviation. If the vehicle speed is less than the minimum speed, the maximum steering value is set to 0.01; otherwise, the maximum steering value is set to the minimum of (1) the absolute value of the angle between the two vectors divided by 50 and (2) the scalar 1.

Target Speed: The target speed is 30 km/h. There are two variables of 0.1 to act as units to change the throttle and brake values. For each time-step, if the vehicle speed is less than the target speed, the brake is set to 0 and the throttle is increased by 0.1, capped at 1; otherwise, the throttle is set to 0 and the brake is increased by 0.1, capped at 1.

Output Values: Algorithm 1 outputs the throttle, steer, and brake values for the next time-step.

Complexity Analysis: Algorithm 1 has 3 location inputs (i.e., x-y pairs) and 3 vehicle control signal inputs (i.e., scalars). The outputs are 3 vehicle control signals. The time complexity is 0 (1); the space complexity is 0 (1). For compute before running Algorithm 1, finding the location from the ground-truth path closest to the predicted vehicle location at the next time-step (i.e., lprediction) has time complexity O (n) for n locations in the path.

Adaptive Fast-Drive Method: The adaptive fast-drive method is as follows: lap times exist where the vehicle stays on three-quarters throttle when the steering correction is less than or equal to five degrees; steer value is set to straight. When the steering correction is greater than five degrees, the vehicle modulates throttle, aiming for ||\vec{v}_{target}|

FIG. 8 illustrates Algorithm 2: an algorithm for steer angle. FIG. 9 illustrates Algorithm 3: an algorithm for steer signal. Moreover, FIG. 10 illustrates Algorithm 4: an algorithm for throttle and brake logic.

TABLE I
Baseline Lap Times

| Target Speed (km/h) | Lap Time (s) |
|---|---|
| 30 | 302.10 |
| 40 | 228.85 |
| 50 | 184.25 |
| 60 | 154.70 |
| 70 | 133.60 |
| 80 | 118.10 |

Table I: shows the lap times at target speeds of 30 through 80 km/h, at 10 km/h increments. In Algorithm 4 line 2, the scalar|v_{target}| changes. In Algorithm 2 line 3, steer Divisor is held constant at 50.

Results: Results show the path following has close adherence to the ground-truth path. The distance between the two lane lines is about 3 meters. As shown in FIG. 2, the distance of deviation from the ground-truth path is within 1.5 meters. The ground-truth drive takes advantage of the road course being 5 lanes wide by driving across the full width of the road through turns. At faster speeds, there is less distance of deviation. Similarly, as shown in FIG. 6, the steering correction necessary to keep the car on the ground-truth path reduces as vehicle speed increases. From FIG. 7, the vehicle closely follows the ground-truth path.

Experimentation starts with steerDivisor=50. As shown in Table I, the path-following algorithm works well at maintaining speeds from 30 km/h to 80 km/h. At a target speed of 90 km/h, the vehicle loses control and is not able to finish the drive.

Below 30 km/h, the vehicle is unable to follow the path at 20 km/h and instead drives in a circle; presumably, even less steering correction is needed to maintain path following at speeds below 30 km/h.

TABLE II
Lap Times with Changing Steer Divisor
(30 km/h) for the Tesla Model 3

| Steer Divisor | Lap Time (s) |
|---|---|
| 25 | 302.50 |
| 50 | 302.10 |
| 75 | 302.25 |
| 100 | 302.35 |

TABLE III
Lap Times with Changing Steer Divisor
(80 km/h) for Tesla Model 3

| Steer Divisor | Lap Time (s) |
|---|---|
| 25 | 117.65 |
| 50 | 118.10 |
| 75 | 118.30 |
| 100 | 118.35 |

From Table II, setting the target speed to 30 km/h, the lap time is similar across 4 steer divisor values. Table III also demonstrates that at target speed 80 km/h also the steer divisor does not affect lap time.

TABLE IV
Lap Times for Different Vehicles

| Vehicle | Lap Time (s) |
|---|---|
| Tesla Model 3 | 118.10 |
| Ford Ambulance | 111.75 |
| Ford Crown (taxi) | 115.10 |

As shown in Table IV, trying different vehicles (i.e., Tesla Model 3, Ford Ambulance, and Ford Crown (taxi)) showcases the difference in performance of this steering control algorithm. This steering control algorithm works best on the Ford Ambulance at 111.75 seconds, a 5.38% improvement from the baseline Tesla Model 3. The vehicles could not complete the course at speeds of 90 km/h and higher.

TABLE V
Lap Times with Adaptive Fast-Drive Method

| | Target Speed (km/h) | | | | | |
|---|---|---|---|---|---|---|
| Vehicle | 30 | 40 | 50 | 60 | 70 | 80 |
| Tesla | 125.00 | 123.55 | 118.35 | 115.20 | 110.80 | U-turn |
| Model 3 | | | | | | |
| Ford | 148.20 | 132.25 | 129.65 | 122.85 | 120.15 | Crash |
| Ambulance | | | | | | |
| Ford | Speed | U-turn | 116.45 | 117.20 | Speed | Speed |
| Crown | dropped | | | | dropped | dropped |
| (taxi) | | | | | | |

Adaptive Fast Drive Method: The Adaptive Fast-Drive Method still does not use machine learning. From Table V, the adaptive fast-drive method improves vehicle lap times. FIG. 5 illustrates graphs corresponding to the adaptive fast-drive method at 30, 60, and 80 km/h for the Tesla Model 3.

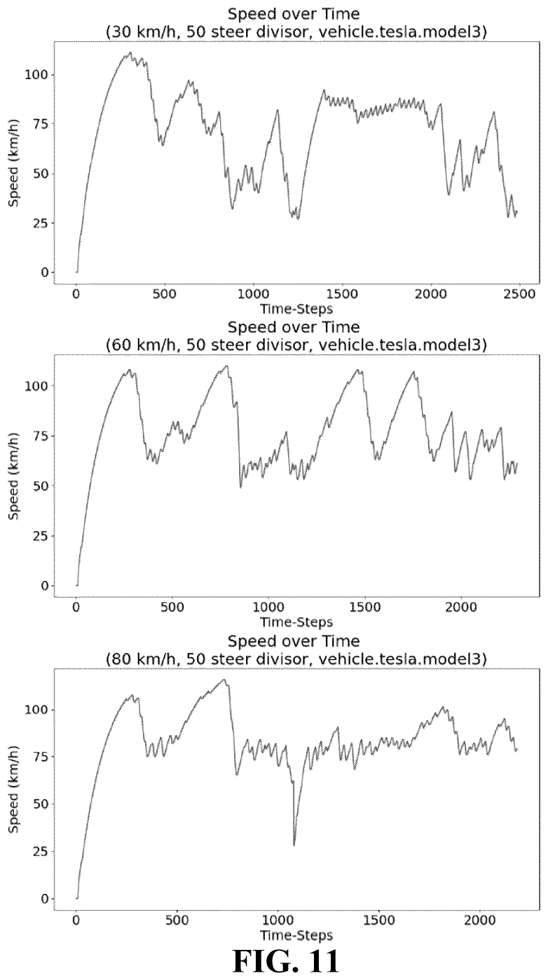

As shown in Table V, there are speeds too low and too high where the adaptive fast-drive method will not work. The Tesla Model 3 and Ford Ambulance had the fastest laps at target speeds of 70 km/h. The Ford Crown had the fastest lap at a target speed of 50 km/h. As shown in FIG. 11, the Tesla Model 3 reaches a top speed of 100 km/h using the adaptive fast-drive method. When steering correction is less than or equal to 5 degrees, the vehicle applies three-quarters throttle with no steering correction.

In Algorithm 2 line 3, the scalar steerDivisor is held constant at 50. In Algorithm 4 line 2, ||\vec{v}_{target}|| changes in increments of 10 from 30 to 80. When a cell in the table does not include a lap time, there is a specified reason why the vehicle did not provide a time: (1) the speed dropped too low (i.e., fishtail, oversteer); the vehicle made a U-turn to head back to the finish line instead of staying on route; or (3) the vehicle crashed.

At the minimum operable bounds, no vehicle could complete the road course with a target speed of 80 km/h. Additionally, the Ford Crown could not complete at target speeds of 30, 40, and 70 km/h.

As used in this specification and the claims, the singular forms “a,” “an,” and “the” include plural forms unless the context clearly dictates otherwise.

As used herein, “about”, “approximately,” “substantially,” and “significantly” will be understood by persons of ordinary skill in the art and will vary to some extent on the context in which they are used. If there are uses of the term which are not clear to persons of ordinary skill in the art given the context in which it is used, “about” and “approximately” will mean up to plus or minus 10% of the particular term.

As used herein, the terms “include” and “including” have the same meaning as the terms “comprise” and “comprising.” The terms “comprise” and “comprising” should be interpreted as being “open” transitional terms that permit the inclusion of additional components further to those components recited in the claims. The terms “consist” and “consisting of” should be interpreted as being “closed” transitional terms that do not permit the inclusion of additional components other than the components recited in the claims. The term “consisting essentially of” should be interpreted to be partially closed and allowing the inclusion only of additional components that do not fundamentally alter the nature of the claimed subject matter.

The phrase “such as” should be interpreted as “for example, including.” Moreover, the use of any and all exemplary language, including but not limited to “such as”, is intended merely to better illuminate the invention and does not pose a limitation on the scope of the invention unless otherwise claimed.

Furthermore, in those instances where a convention analogous to “at least one of A, B and C, etc.” is used, in general such a construction is intended in the sense of one having ordinary skill in the art would understand the convention (e.g., “a system having at least one of A, B and C” would include but not be limited to systems that have A alone, B alone, C alone, A and B together, A and C together, B and C together, and/or A, B, and C together.). It will be further understood by those within the art that virtually any disjunctive word and/or phrase presenting two or more alternative terms, whether in the description or figures, should be understood to contemplate the possibilities of including one of the terms, either of the terms, or both terms. For example, the phrase “A or B” will be understood to include the possibilities of “A” or “B” or “A and B.”

All language such as “up to,” “at least,” “greater than,” “less than,” and the like, include the number recited and refer to ranges which can subsequently be broken down into ranges and subranges. A range includes each individual member. Thus, for example, a group having 1-3 members refers to groups having 1, 2, or 3 members. Similarly, a group having 6 members refers to groups having 1, 2, 3, 4, or 6 members, and so forth.

The modal verb “may” refers to the preferred use or selection of one or more options or choices among the several described embodiments or features contained within the same. Where no options or choices are disclosed regarding a particular embodiment or feature contained in the same, the modal verb “may” refers to an affirmative act regarding how to make or use an aspect of a described embodiment or feature contained in the same, or a definitive decision to use a specific skill regarding a described embodiment or feature contained in the same. In this latter context, the modal verb “may” has the same meaning and connotation as the auxiliary verb “can.”

In the foregoing specification, implementations of the disclosure have been described with reference to specific example implementations thereof. It will be evident that various modifications may be made thereto without departing from the broader spirit and scope of implementations of the disclosure as set forth in the following claims. The specification and drawings are, accordingly, to be regarded in an illustrative sense rather than a restrictive sense.

1. An autonomously driving vehicle comprising:
at least one environmental sensor;
a processor;
a controller connected to a steering system, a brake system, and an acceleration system;
a memory having instructions stored thereon that, when executed, cause the controller to:
receive data corresponding to physical locations within an environment in which the vehicle is operating, at least one of the physical locations associated with a target location;
determine a ground truth path within the environment, based on the plurality of GPS locations, wherein the ground truth path comprises a plurality of ground truth path locations;
obtain, using the at least one environmental sensor, a current vehicle location;
determine an extrapolated vehicle location based on a plurality of operating parameters of the steering system, the brake system, and the acceleration system;
compare the extrapolated vehicle location to each location of the plurality of ground truth path locations;
output a throttle value, a steer value, and a brake value based on a closest location of the plurality of ground truth locations; and
adjust the plurality of operating parameters of the steering system, the brake system, and the acceleration system based on the throttle value, the steer value, and the brake value.

2. The vehicle of claim 1, wherein the at least one environmental sensor comprises at least one of a camera, an infrared sensor, a radar system, or a GPS module.

3. The vehicle of claim 1, wherein the plurality of operating parameters comprises a current throttle value, a current steer value, a current brake value, and a current velocity.

4. The vehicle of claim 3, wherein the throttle value is computed by comparing the current throttle value and the current velocity to a target velocity.

5. The vehicle of claim 4, further comprising:
a user interface,
wherein the target velocity is received from a user via the user interface.

6. The vehicle of claim 3, wherein the steer value comprises an angle, wherein the angle is computed by a difference between a first vector based on the current vehicle location and the extrapolated vehicle location, and a second vector based on the current vehicle location and a ground truth path location closest to the extrapolated vehicle location.

7. A method for adaptive autonomous driving, the method comprising:
receiving a plurality of global positioning system (GPS) locations corresponding to an environment in which a vehicle is operating in;
determining a ground truth path based on the plurality of GPS locations, wherein the ground truth path comprises a plurality of ground truth path locations;
obtaining, using at least one environmental sensor, a current vehicle location;
determining an extrapolated vehicle location based on a plurality of operating parameters of a steering system, a brake system, and an acceleration system;
comparing the extrapolated vehicle location to each location of the plurality of ground truth path locations;
outputting a throttle value, a steer value, and a brake value based on a closest location of the plurality of ground truth locations; and
adjusting the plurality of operating parameters of the steering system, the brake system, and the acceleration system based on the throttle value, the steer value, and the brake value.
